(19) United States
(12) Patent Application Publication
(10) Pub. No.: US 2014/0032730 A1
(43) Pub. Date: Jan. 30, 2014

(54) DELAY-TOLERANT WEB TRANSACTION DELEGATIONS

(71) Applicant: QUALCOMM INCORPORATED, San Diego, CA (US)

(72) Inventors: Kevin Roland FALL, Bethel Park, PA (US); Dilip KRISHNASWAMY, San Diego, CA (US)

(73) Assignee: QUALCOMM INCORPORATED, San Diego, CA (US)

(21) Appl. No.: 13/763,968

(22) Filed: Feb. 11, 2013

Related U.S. Application Data
(60) Provisional application No. 61/675,908, filed on Jul. 26, 2012.

(51) Int. Cl. H04L 29/08

(52) U.S. Cl. CPC H04L 67/02
USPC 709/223

(57) ABSTRACT

Embodiment methods and systems enable completing online transactions when there is insufficiently reliable connectivity between the initiating computing device and the remote server to enable completing the transaction directly. Transactions in such situations are accomplished using a RESTful Delay Tolerant Network. A set of messages constituting the web transaction are bundled, together with instructions and other metadata, in a manner that enables intermediate nodes in the network to complete the transactions on behalf of the source computing device. The source computing device then delegates the web transaction to an intermediate node. If the intermediate node can complete the transaction with the destination device, it does so on behalf of the source computing device. If not, the intermediate node delegates the web transaction to another intermediate node, which may be repeated until an intermediate node is able to complete the transaction with the destination.

### RELATED APPLICATION

This application claims the benefit of priority to U.S. Provisional Patent Application No. 61/675,908 entitled “Delay-Tolerant Web Transaction Delegations” and filed on Jul. 26, 2012, the entire contents of which are hereby incorporated by reference.

### FIELD

This application generally relates to delay tolerant networking, and more particularly to Representational State Transfer Delay Tolerant Networking (RESTful DTN) systems and methods for providing web-based network communications by delegating one or more web transactions to intermediate network entities.

### BACKGROUND

In conventional TCP/IP based networks, completing web transactions is generally not possible unless end-to-end TCP/IP connectivity is present. Techniques known as Delay Tolerant Networking (“DTN”) have been developed to address connectivity issues when networks have intermittent or problematic connections. DTN allows data to be stored, carried, and forwarded along each hop between network nodes. End-to-end contemporaneous connectivity is not required; only an “eventual” end-to-end path needs to be present for data transfer to occur. However, conventional DTN techniques do not allow for robust web transactions to be completed across intermittent networks.

The DTN approach implements the store-and-forward message handling by overlaying a bundle layer protocol between the application layer and another layer in the protocol stack. A bundle is a protocol data unit of the DTN bundle protocol. The bundle layer ties together with the other layers so that application programs may communicate across intermittent networks. The bundle layer stores and forwards messages between DTN Nodes. The bundle layer also supports DTN Node to DTN Node transmission using custody transfers where delivery responsibility may be moved from one node to another.

Conventional DTN techniques may overcome the problems associated with intermittent networks by using a store-and-forward message switching technique. Here, blocks of messages, called bundles, may be moved through the network from a storage place on one device to a storage place on another device, along a path that eventually reaches the destination host. The store and forward technique may be implemented by DTN nodes in each device on the network, along with persistent storage in each device that may hold messages indefinitely.

In summary, the conventional Delay Tolerant Network (DTN) techniques may handle intermittent networks by forwarding and processing bundles as described above. However, existing DTN approaches do not support web transactions, and may lack flexibility regarding how web transactions may take place within the network.

### SUMMARY

The various embodiments are directed to systems and methods for conducting robust web-based transactions over networks that may have intermittent connections or that require connections between interconnected networks using different protocols. Embodiments described herein provide for extensions to existing DTN techniques to enable web transactions over intermittent networks, and to permit network entities to delegate web transactions from one network device to another in a delay tolerant fashion. Such delegations may provide connectivity scenarios that have greater spatial flexibility in terms of what transmission paths may be used for web transactions, and provide greater temporal flexibility as to when and how resources may be utilized by users. These extensions apply DTN concepts, along with Representational State Transfer (REST), to formulate a new networking approach referred to herein as RESTful DTN.

Based on existing DTN techniques, RESTful DTN can make robust web transactions over networks that may not have continuous connections (i.e., communications may be asynchronous, unavailability of nodes, or discontinuities between hops). Instead of handing over custody of a bundle as in conventional DTN approaches, the DTN fabric may be extended in RESTful DTN by delegating an entire set of web transactions to one or more intermediate devices.

RESTful DTN, which can be implemented over TCP/IP networks, has the following three abilities that are not found in conventional Delay Tolerant Networks: the ability to leverage conventional DTN bundle protocol and storage abstraction to tolerate disconnections over intermittent networks, in combination with techniques for delegating web transactions; the ability to integrate web transactions utilizing the HTTP protocol into the context of the conventional DTN fabric; and the ability to use the DTN protocol to span web transactions over non-TCP/IP networks.

An embodiment method for providing robust web transactions over a network exhibiting intermittent conductivity between a source computing device and a destination device may include combining Delay Tolerant Networking (DTN) techniques with a Representational State Transfer (REST) architecture to enable transmission of web transactions over networks with intermittent connectivity by delegating the entire transaction to intermediate network nodes. In an embodiment, delegating the entire transaction to intermediate nodes may include aggregating, in the source computing device, a sequence of operations constituting the web transaction between the source computing device and the destination device, combining, in the source computing device, data objects and handling instructions, including delay tolerance information for the web transaction, into a set of messages constituting the web transaction, encapsulating data of the set of messages in bundles using HTTP payloads, and delegating the set of messages from the source computing device to an intermediate device in a manner that enables the intermediate device to complete the web transaction with the destination device on behalf of the source computing device. An embodiment method may further include combining, in the destination device, a confirmation message, handling instructions, including delay tolerance information for the confirmation message into a confirmation package, encapsulating data of the confirmation package in bundles using HTTP payloads, and delegating the confirmation package from the destination device to an intermediate device.

An embodiment method for providing robust web transactions over a network exhibiting intermittent conductivity between a source computing device and a destination device may include receiving at a first network node a set of messages constituting a web transaction, a data object, handling instructions and delay tolerance parameters from one of a source computing device and another network node. The method further may further include determining whether sufficient network connectivity exists between the first network node and a destination of the web transaction to enable completion of the web transaction, completing, by the first network node, the web transaction on behalf of the source computing device by transmitting the set of messages to the destination according to the handling instructions in response to determining that there is sufficient network connectivity between the first network node and the destination to complete the web transaction, and forwarding to a second network node the set of messages constituting a web transaction, a data object, handling instructions and delay tolerance parameters in response to determining that there is insufficient network connectivity between the first network node and the destination to complete the web transaction. In an embodiment combining, in the destination device, a confirmation message, handling instructions, including delay tolerance information for the confirmation message into a confirmation package, encapsulating data of the confirmation package in bundles using HTTP payloads, and delegating the confirmation package from the destination device to an intermediate device. In an embodiment communications of and with the network node are accomplished according to a Representational State Transfer (REST) architecture, or according to a Simple Object Access Protocol (SOAP) architecture. In an embodiment forwarding to a second network node the set of messages constituting a web transaction, a data object, handling instructions and delay tolerance parameters may include determining the second network node to which the web transaction should be relayed, and delegating the web transaction to the second network node. In an embodiment determining whether there is network connectivity to the second network node sufficient to transmit the set of messages constituting a web transaction, a data object, handling instructions and delay tolerance parameters, transmitting the set of messages constituting a web transaction, a data object, handling instructions and delay tolerance parameters in response to determining that there is sufficient network connectivity to complete the transmission, and storing the web transaction, a data object, handling instructions and delay tolerance parameters for later transmission in response to determining that there is insufficient network connectivity to complete the transmission. The method further may further include determining from the delay tolerance parameters whether the web transaction has expired, transmitting the set of messages constituting a web transaction, a data object, handling instructions and delay tolerance parameters in response to determining that the web transaction has not expired, and deleting the set of messages constituting a web transaction, a data object, handling instructions and delay tolerance parameters in response to determining that the web transaction has expired. The method further may further include scheduling transmission of the web transaction, a data object, handling instructions and delay tolerance parameters to the second network node based on the delay tolerance parameters, in which scheduling transmission of the web transaction, a data object, handling instructions and delay tolerance parameters to the second network node based on the delay tolerance parameters comprises expediting transmission of the web transaction to the second network node in response to determining that the web transaction will soon expire.

In an embodiment, a source computing device may include a network interface and a processor coupled to the network interface, in which the processor is configured with processor-executable instructions to perform operations including aggregating a sequence of operations constituting the web transaction between the source computing device and the destination device, combining data objects and handling instructions, including delay tolerance information for the web transaction, into a set of messages constituting the web transaction, encapsulating data of the set of messages in bundles using HTTP payloads, and delegating the set of messages to an intermediate device in a manner that enables the intermediate device to complete the web transaction with the destination device on behalf of the source computing device. A further embodiment includes a source computing device having means for accomplishing the functions of the methods listed above. A further embodiment includes a non-transitory computer-readable storage medium having stored thereon processor executable instructions configured to cause a computing device processor to perform operations of the methods listed above.

In a further embodiment, a server may be configured to function as a first network node in a communication network. Such an embodiment server may include a memory, a network interface, and a processor coupled to the memory and network interface, in which the processor is configured with processor-executable instructions to perform operations including receiving a set of messages constituting a web transaction, a data object, handling instructions and delay tolerance parameters from one of a source computing device and another network node, determining whether sufficient network connectivity exists between the server and a destination of the web transaction to enable completion of the web transaction, completing the web transaction on behalf of the source computing device by transmitting the set of messages to the destination according to the handling instructions in response to determining that there is sufficient network connectivity between the server and the destination to complete the web transaction, and forwarding to a second network node the set of messages constituting a web transaction, a data object, handling instructions and delay tolerance parameters in response to determining that there is insufficient network connectivity between the server and the destination to complete the web transaction. In an embodiment, communications of and with the server may be accomplished according to a Representational State Transfer (REST) architecture or a Simple Object Access Protocol (SOAP) architecture. In an embodiment, forwarding to a second network node the set of messages constituting a web transaction, a data object, handling instructions and delay tolerance parameters may include determining the second network node to which the web transaction should be relayed, and delegating the web transaction to the second network node. In an embodiment, the server processor may be configured with processor-executable instructions to perform operations further including determining whether there is network connectivity to the second network node sufficient to transmit the set of messages constituting a web transaction, a data object, handling instructions and delay tolerance parameters, transmitting the set of messages constituting a web transaction, a data object, handling instructions and delay tolerance parameters in response to determining that there is sufficient network connectivity to complete the transmission, and storing the web transaction, a data object, handling instructions and delay tolerance parameters for later transmission in response to determining that there is insufficient network connectivity to complete the transmission. In an embodiment, the server processor may be configured with processor-executable instructions to perform operations further including determining from the delay tolerance parameters whether the web transaction has expired, transmitting the set of messages constituting a web transaction, a data object, handling instructions and delay tolerance parameters in response to determining that the web transaction has not expired, and deleting the set of messages constituting a web transaction, a data object, handling instructions and delay tolerance parameters in response to determining that the web transaction has expired. In an embodiment, the server processor may be configured with processor-executable instructions to perform operations further including scheduling transmission of the web transaction, a data object, handling instructions and delay tolerance parameters to the second network node based on the delay tolerance parameters, which may include expediting transmission of the web transaction to the second network node in response to determining that the web transaction will soon expire. A further embodiment includes a server having means for accomplishing the functions of the methods listed above. A further embodiment includes a non-transitory server-readable storage medium having stored thereon server processor executable instructions configured to cause a server to perform operations of the methods listed above.

A further embodiment may include a computing device configured to function as a transaction destination computer, that includes a network interface, and a processor coupled to the network interface, in which the processor is configured with processor-executable instructions to perform operations including combining into a confirmation package a confirmation message confirming completion of a transaction initiated by a source computing device that was delegated for completion by an intermediary computing device, handling instructions, including delay tolerance information for the confirmation message, encapsulating data of the confirmation package in bundles using HTTP payloads, and delegating the confirmation package from the destination device to an intermediate device. A further embodiment includes a transaction destination computer having means for accomplishing the functions of the methods listed above. A further embodiment includes a non-transitory computer-readable storage medium having stored thereon server processor executable instructions configured to cause a transaction destination computer to perform operations of the methods listed above.

A further embodiment includes system for providing robust web transactions over a network exhibiting intermittent conductivity that includes a source computing device, a server functioning as an intermediate network node, and a destination computing device, each of which are configured to perform respective operations of the methods described above. In such an embodiment, the source computing device, the server functioning as an intermediate network node and the destination computing device may be configured to combine Delay Tolerant Networking (DTN) techniques with a Representational State Transfer (REST) architecture to enable transmission of web transactions over networks with intermittent connectivity by delegating the entire transaction to the server functioning as an intermediate network node.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a top level block diagram of a conventional Delay Tolerant Network.

FIG. 2 is a top level block diagram of an embodiment of a RESTful Delay Tolerant Network.

FIG. 3 is a block diagram showing details of two RESTful DTN nodes and their associated processing and communications per hop.

FIG. 4A is a block diagram illustrating an example of generic messaging details between RESTful DTN Nodes.

FIG. 4B is a block diagram illustrating an example of publication/subscription (Pub/Sub) messaging details between RESTful DTN Nodes.

FIG. 5A is a block diagram of a RESTful DTN illustrating aspects that may be associated with multihop and multicast network configurations.

FIG. 5B is a block diagram of a RESTful DTN in a heterogeneous multihop configuration.

FIG. 6 is a block diagram of a RESTful Delay Tolerant Network that may be used with classes of web applications to provide additional features for improving performance and reliability.

FIG. 7 is a block diagram illustrating an embodiment Core RESTful DTN Middleware.

FIG. 8 is a process flow diagram illustrating operations among selected DTN devices and top-level processes according to various embodiments.

FIG. 9 is a process flow diagram illustrating an embodiment method for packaging transaction communications for delegation to intermediate nodes.

FIG. 10 is a component block diagram of a mobile computing device suitable for use in an embodiment.

FIG. 11 is a component block diagram of a personal computing device suitable for use in an embodiment.

FIG. 12 is a component block diagram of a server suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

There are many situations and locations in which computing device users do not have the reliable Internet connectivity to complete on-line transactions with a remote server. This can be very inconvenient given the ever-increasing importance of online commerce and electronic transactions. The various embodiments provide methods and systems that enable completing online transactions when there is not the reliable connectivity between the initiating computing device and the remote server completing the transaction. Transactions in such situations are accomplished in the various embodiments using a RESTful Delay Tolerant Network.

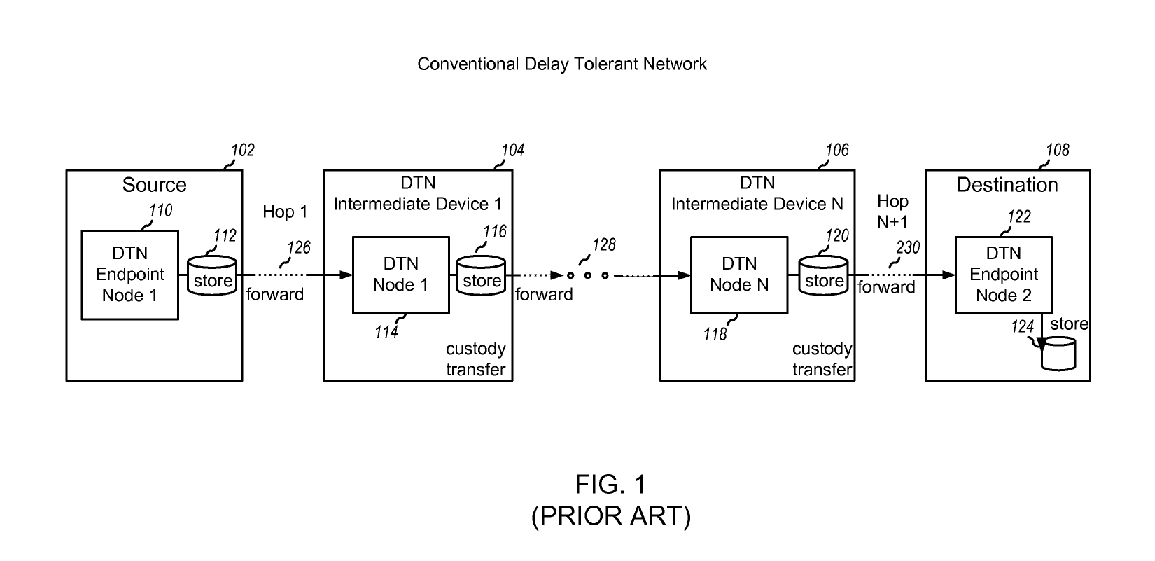

FIG. 1 is a top level block diagram of a conventional Delay Tolerant Network (DTN). The DTN may include two or more hosts, shown in FIG. 1 as the Source 102 and the Destination 108, which are connected to a number of DTN Intermediate Devices (1, . . . , N) 104 and 106 by a network having a number of hops (Hop 1, . . . , N+1) 126, 128 and 130. The network shown in FIG. 1 lacks continuous connectivity, which may be due to intermittent connectivity between one or more Hops 1, . . . , N (shown by the dashed lines), long or variable delays between hops, asymmetric data rates, or high error rates. Hosts may be a computer or other similar communicating device, such as, a tablet computer, a mobile device, a smart phone, or another other type of communicating device, that may be the source or destination of transaction-related messages. In the DTN shown in FIG. 1, the Source 102 is the source of the messages, which may be generated, for example, by a Mobile Web Browser. The Destination 108 is the destination for the message, which may be a web server. The message may travel over a number of intermittent hops and devices, including a number of DTN intermediate devices, some of which may be a router, illustrated as DTN Intermediate Device 1 through DTN Intermediate Device N 106.

As shown in FIG. 1, any of DTN Intermediate Device 1 104 and DTN Intermediate Device N 206 may serve as bundle custodians. Each bundle custodian may store a copy of a received bundle in associated storage 116 and 120 until another node accepts custody, the transaction is completed with the destination device, or a lifetime of the bundle expires. By design, the expiration time of a bundle may be longer than the time allowed for a node to accept custody.

Conventional DTN techniques may overcome the problems associated with intermittent networks by using a store-and-forward message switching technique. In such a technique, blocks of messages, called bundles, may be moved through the network from a storage place on one device to a storage place on another device, along a path that eventually reaches the destination host. The store and forward technique may be implemented by DTN nodes in each device on the network, along with persistent storage in each device that may hold messages indefinitely. As shown in FIG. 1, the DTN nodes in the Source 102 and the Destination 108 are DTN Endpoint Nodes 1 and 2, respectively, blocks 110 and 122. The DTN Intermediate Devices include DTN Nodes 1, block 104 through N, block 106.

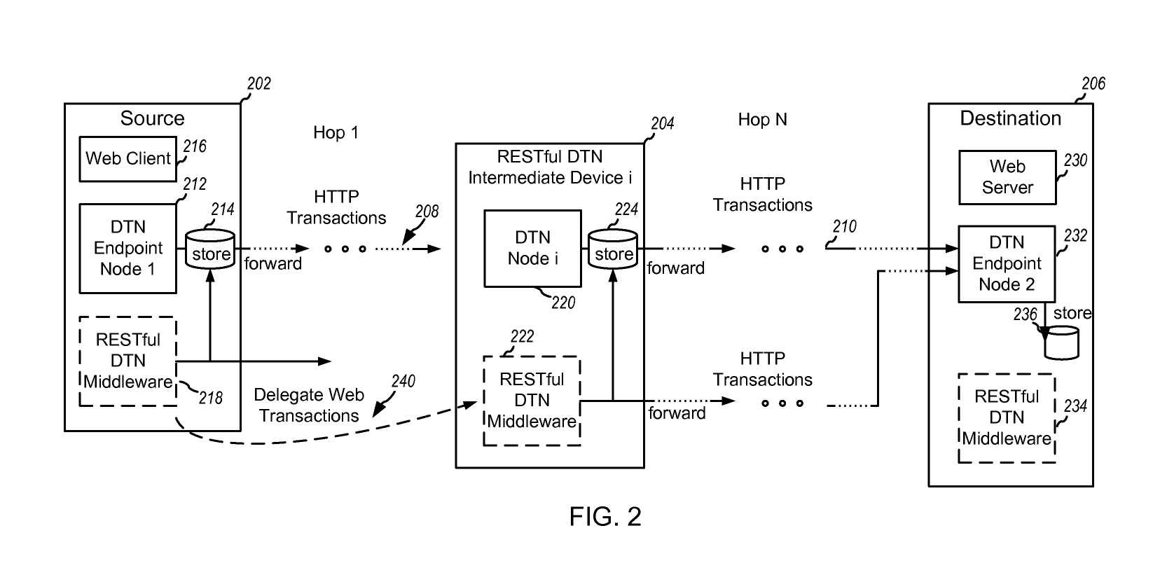

FIG. 2 is a top level block diagram of an embodiment of a RESTful Delay Tolerant Network (RESTful DTN). For purposes of illustration, transactions between a Source 202, a RESTful DTN Intermediate Device i 204, and a Destination 206 are shown. It should be understood that any number of RESTful Intermediate Devices may be interposed between the Source 202 and the Destination 206. Issues of network intermittent connectivity between the RESTful Intermediate Devices are indicated in FIG. 2 by dashed lines 208 and 210.

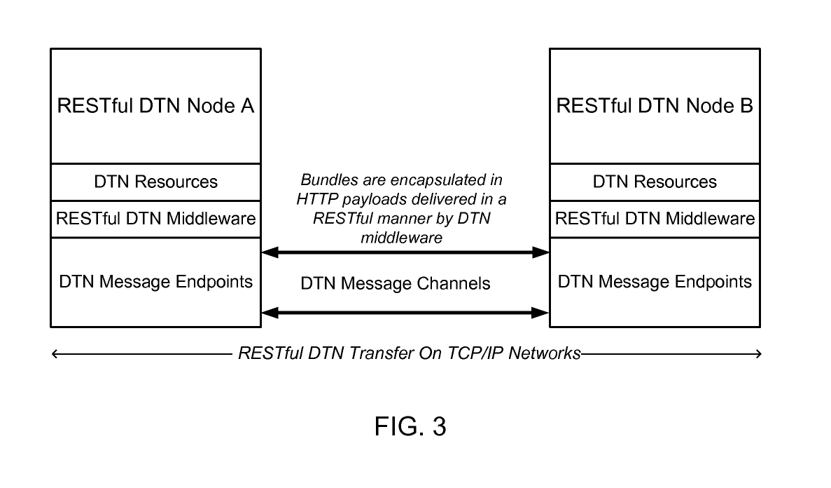

The Source 202 may include a conventional DTN Endpoint Node 1 212 with associated persistent storage 214, a web client 216, and RESTful DTN middleware 218 (which is described in more detail below in FIG. 3). The Source 202 may be, for example, a mobile web browser. RESTful DTN Intermediate Device i 204 may include a conventional DTN Node i 220 with associated persistent storage 224, and RESTful DTN middleware 222 that may share the persistent storage. The Destination 206 may include a conventional DTN Endpoint Node 2 232 with associated persistent storage 236, a web server 230, and RESTful DTN middleware 234. The Destination 206 may be, for example, a web service provider.

The RESTful DTN network may incorporate the techniques of the conventional DTN network as described above in FIG. 1, and operate using store and forward techniques as discussed above to overcome intermittent connections. However, the RESTful DTN network extends conventional DTN techniques by encapsulating bundles using HTTP payloads, thereby permitting transactions between network nodes to be HTTP transactions. The utilization of HTTP methods takes advantage of the existing communication devices already designed to handle this protocol, thereby enabling transitions across NAT/firewalls.

In the various embodiments, the RESTful DTN methods may delegate an entire web transaction to one or more intermediate nodes for completion. In other words, an entire (web) endpoint transaction may be moved from the initiating host to an intermediate device. As shown in FIG. 2, the Source delegates web transactions to RESTful DTN Intermediate Device i. RESTful DTN Intermediate Device i may complete the web transaction, further process the results, and forward the results back to the Source when a connection is available. For example, photos may be requested from the Destination by the Source through RESTful DTN Intermediate Device i. The requested photos may be further processed by RESTful DTN Intermediate Device i by performing facial recognition, for example, and the results culled to a few selected photos. These selected photos may then be passed back to the Source when a connection is available. In other embodiments, RESTful DTN Intermediate Device i may simply obtain the results from the Destination, and optionally provide notification to the Source that the request was fulfilled. When the Source has a valid connection, or at its user's convenience, the Source may receive the results from RESTful DTN Intermediate Device i as if it asked for the resources from the web service (Destination) with which the transaction was completed. In summary, the RESTful DTN delegates an entire web transaction, not just custody of individual bundles as in a conventional DTN, to provide additional flexibility in terms of time and network resources.

Delegation of web transactions may be accomplished within the RESTful DTN middleware by using a data object along with handling instructions expressed as rules that are sent using a custody transfer style operation (acknowledged single-DTN-hop transfer). A node receiving the handling instructions may pass along the data object to the next node and arrange for the handling instructions to be executed upon receipt of some return response. The method is recursive, which may result in a potential chain of deferred triggered executions of handling instructions when intermediate nodes also encounter intermittent communication links. Handling instructions may include but are not limited to an explicit delay tolerance associated with the entire set of bundle transaction blocks in the HTTP content payload, a specification of the final destination ID (e.g., an IP address), a specification of a final destination URI if known, or an algorithm to be utilized to manage the data forwarding based on network constraints and delay considerations over multiple hops in the DTN. Handling instructions may be stored at the resource indicated by a URI, along with the bundle blocks that may be stored at the resource.

The web transaction delegation is accomplished using a Representational State (REST) Transfer, and thus provides a set of instructions defining the state of the node being transferred. An example is shown in FIG. 2, which illustrates a web transaction delegation from the Source to DTN Intermediate Device i. REST transactions are idempotent, which means the transfer may be sent multiple times without changing the state of the destination beyond the initial reception of the transaction. This allows a web transaction to be transmitted more than once and the receiving host would disregard later received transactions that are identical to earlier received transactions.

REST transactions are described in “Architectural Styles and the Design of Network-based Software Architectures,” Doctoral dissertation by Roy Thomas Fielding, University of California, Irvine, which is incorporated herein by reference. The following paragraph includes a description of REST based on Dr. Fielding's dissertation.

REST provides a set of architectural constraints that, when applied as a whole, emphasizes scalability of component interactions, generality of interfaces, independent deployment of components, and intermediary components to reduce interaction latency, enforce security, and encapsulate legacy systems. The central feature that distinguishes the REST architectural style from other network-based styles is its emphasis on a uniform interface between components. REST comes from the code-on-demand style that allows client functionality to be extended by downloading and executing code in the form of applets or scripts. This simplifies clients by reducing the number of features required to be pre-implemented. Allowing features to be downloaded after deployment improves system extensibility. The key abstraction of information in REST is a resource. Any information that can be named may be a resource: a document or image, a temporal service (e.g. “today's weather in Los Angeles”), a collection of other resources, a non-virtual object (e.g. a person), and so on. In other words, any concept that might be the target of an author's hypertext reference must fit within the definition of a resource. A resource is a conceptual mapping to a set of entities, not the entity that corresponds to the mapping at any particular point in time.

FIG. 3 is a block diagram showing details of two RESTful DTN nodes and their associated processing and communications per hop. Each RESTful DTN node includes DTN resources, RESTful DTN Middleware, and DTN message endpoints. The RESTful DTN node may be an agent software service running on a network device, such as, for example, a mobile device, a computer, a server, router, gateway, etc.

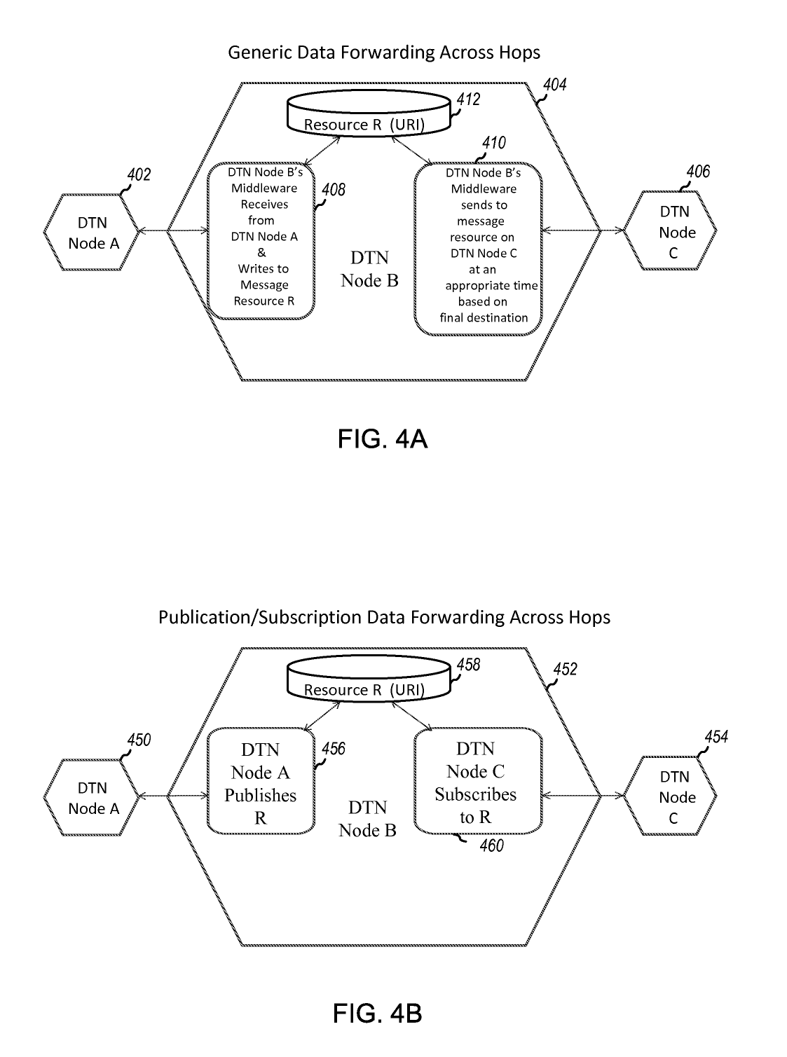

The DTN resources may be stored in the persistent stores shown in FIG. 2, and may include any collection of information in transit, such a document or image, or any type of file. The RESTful DTN Middleware may provide the RESTful style interface to access the resources, and execute HTTP style GETs and PUTs, as will be described in more detail below in FIGS. 4A and 4B. The DTN message endpoints may include the bundle protocol as used in conventional DTN messaging, and further may adapt the middleware to work with the bundle protocol.

DTN Message Channels allow bundles to pass between DTN Message Endpoints. In the context of TCP/IP networks, the bundles may be encoded and/or encapsulated in HTTP payloads so these bundles appear as web traffic to the network infrastructure. In alternative embodiments, bundles may be encoded as XML or JSON for transfer, storage, or processing. Also, the RESTful DTN may be used in conjunction with conventional DTN techniques to provide bundles over networks utilizing other protocols. Thus, the bundles may be sent over alternative networks having different transport, network, link, and/or physical layers in their protocol stack.

Details of relevant HTTP methods may be found in RFC 2616, which is incorporated herein by reference. Relevant excerpts of RFC 2616 are provided in the four paragraphs below.

The HTTP protocol is a request/response protocol. A client sends a request to the server in the form of a request method, URI, and protocol version, followed by a MIME-like message containing request modifiers, client information, and possible body content over a connection with a server. The server responds with a status line, including the message's protocol version and a success or error code, followed by a MIME-like message containing server information, entity meta information, and possible entity-body content.

Most HTTP communications are initiated by a user agent and include a request to be applied to a resource on some origin server. In the simplest case, this may be accomplished via a single connection between the user agent and the origin server.

Additionally, the DTN nodes may communicate directly with each other in a peer-to-peer manner to exchange information regarding network conditions. The RESTful DTN middleware may perform these peer-to-peer communications over HTTP, or over lower level protocols such as TCP or UDP. The information exchanged regarding network conditions may include metrics such as link quality and/or utilization, message queue sizes, per hop delays, and/or aggregate delays over multiple hops. These communications may occur in the background while normal RESTful DTN operations are being performed, so that these metrics may be refined to improve their accuracy over time. Moreover, continuous monitoring of the network may provide an early indication of network problems before serious problems develop.

FIG. 4A is a block diagram illustrating an example of generic messaging details between RESTful DTN Nodes. A first node 402 may sends a message to a second node 404. The second node 404 may receive the message in block 408 and may write the message to a generic message resource 412 used by the node middleware to manage data forwarding to perform delay tolerant data transfer management for each hop. In block 410, the second node 404 may determine the appropriate time to forward the message to a third node 406. During communication, HTTP specifies a REQUEST method and a Uniform Resource Identifier (URI), such as a web address specifying a destination for writing the message body.

A REQUEST method is typically one of the four “CRUD” operations:

Create - POST;
Retrieve - GET;
Update - PUT;
Delete - DELETE;

The content for the HTTP payload may be a bundle, such as defined in the Bundle protocol described in “DTN: An Architectural Retrospective,” Kevin Fall and Stephen Farrell, IEEE Journal on Selected Areas in Communications, Vol. 26, No. 5, June 2008, which is incorporated herein by reference. Each bundle may include a header.

The DTN delivery may utilize various existing as well as to-be-developed routing protocols. The Header field in a Bundle Block may contain a “Creation Timestamp” and a “Lifetime” of the packet. In an embodiment, based on the header field in Bundle Block information, the DTN middleware may be aware of the time remaining for delivery. The DTN middleware may be in contact with the next DTN node in the path, which may be in contact occasionally with the next node in the path, and so on, so that intermediate nodes may have some estimate of an “expected delay across remaining hops.” Based on such an estimate, the DTN middleware may estimate a delay tolerance on the current hop for the packet to be delivered, and decide whether to postpone the delivery of the packet to the next destination. However, if there is a time-slack T available to be shared across the hops, and there are (N−k) remaining hops at the k^{th} DTN node, then the middleware may assign itself a slack (“TimeSlack for this hop”) of T/(N−k). Other non-equal partitioning of the slack is also possible.

This time-slack T would be an estimate based on the “remaining time” and the “expected delay across hops”. The “remaining time” may be estimated using a calculation using information included in the bundle header, such as “Creation TimeStamp”+“LifeTime”−“CurrentTimeStamp” when the payload arrives. A “delay tolerance on the next hop” may be computed using “Expected delay on current hop”+“Time Slack for this hop.”

If T is not available, then the DTN middleware may make a rough estimate based on the remaining time, and an expected number of remaining hops (N−k) (for example if the expected delay across hops” is not available), and assigns a “delay tolerance” of “remaining time”/(N−k).

Other routing protocols may be used in other embodiments, for example, such as those described in, “Probabilistic routing in intermittently connected networks,” by A. Lindgren, A. Doria and O. Scheln, Proceedings of the Fourth ACM International Symposium on Mobile Ad Hoc Networking and Computing, 2003, which is incorporated herein by reference. Additionally, bundle protocols that are modified to include a header with the “remaining time” as data is forwarded may be used in various embodiments.

In TCP/IP networks, the DTN middleware may store a message (POST or PUT) at the URI specified for the message Resource, select an appropriate destination for the next hop based on the final destination for the bundle, identify a URI to POST/PUT the message into the next hop, and submit the POST/PUT request when connectivity for the next hop is available and selected and based on the delay tolerance. The middleware may postpone connectivity to forward multiple bundles, for example, to avoid unnecessary repeated connection requests. Alternatively, the connectivity may simply be not available until the next connection. In some embodiments, a message may be deliberately delayed based on knowledge of the delay tolerance of the data, the network load, or link conditions, or with a goal to aggregate messages for a future transmission for reducing power utilization or improved network utilization. As the data is forwarded, associated with the bundle blocks may be handling instructions stored at the resource location indicated by the URI. While the data may be stored at intermediate nodes, it may be queried using web queries if needed for diagnostics.

Besides exchanging bundle data using HTTP CRUD requests, DTN middleware may communicate messages directly peer-to-peer between any two DTN nodes using HTTP. The reference resources may convey information about dynamic network states, for example, latency, effective bandwidth, and/or availability. The reference resources may include further metrics, such as current message queue sizes, local network conditions such as network load or link qualities, single hop expected delays, multihop path delays (example total expected delay from a given node to a desired multihop destination), etc. If using HTTP, these messages may be additional resources that get updated, and are proactively used by the DTN middleware to take decisions on expected multihop delays, or to plan for a future transmission time based on current network conditions. Alternatively, these messages may be exchanged over UDP sessions or TCP sessions between the peer DTN middleware endpoints on the DTN nodes. When using UDP, it is possible that some messages may be lost in transit. In such cases, the intended recipient DTN node merely uses its latest successfully received information regarding such metrics.

When a first DTN node creates a resource on a second DTN node, the resource may be tagged with ownership information regarding the node that created the resource, so that only that first DTN node may be allowed to update that resource.

HTTPS transactions can be used to securely transfer bundles from one DTN node to another. Additionally, security may be assured by sending encrypted data with an unencrypted header to handle the transfer of custody from one node to another without revealing the associated data which remains encrypted according to the HTTPS protocol.

In further embodiments, other technologies, such as SOAP or WSDL, may be used in place of REST to accomplish robust web transactions over intermittent networks. If using SOAP or WSDL, for example, every pair of nodes along the path may negotiate the message format and communication protocol to be used, encryption methods to be used and determine the DTN parameters of the data transfer.

When a resource is updated, the DTN middleware may look for any subscribers associated with that resource, and may subsequently plan for a delay tolerant transmission of the bundle to the intended recipients. The middleware may take into account the creation time, the lifetime of the bundle, any expected next hop or multihop path delays, an expected number of hops, and network connectivity information, to make a decision on when to next transmit the bundle on the multihop path. If there are no subscribers (in the generic resource case), the DTN middleware may analyze information in the header field in the Bundle Block to determine the final destination as well as the next hop for that destination. The DTN middleware may cache information on previously mapped bundles intended for a given destination.

The DTN middleware may update the header field in Bundle Block if the header has a field such as a “remaining time” field (not specified in Fall and Farrell paper but other variants could do that).

The DTN middleware may also process and transform the bundle contents if it is allowed or requested to do so. In such as case, the processed bundle may be forwarded to the next hop

The DTN middleware may also have filters to process the bundle contents to expedite the delivery of a bundle, based on pre-specified criteria such as a value of an observation data or derived data, or whether a metric exceeds a certain pre-specified threshold, or falls below a certain pre-specified threshold.

FIG. 4B is a block diagram illustrating an example of publication/subscription (Pub/Sub) messages passing between RESTful DTN Nodes according to an embodiment. The Pub/Sub operations may be performed by the middleware in Node B, block 452, to manage data forwarding. The middleware may handle the delay tolerant data transfer to receive data from a resource publisher 450, and the delay tolerant handling of notifications to forward data to a resources subscriber 454.

As illustrated in FIG. 4B, the DTN middleware 452 may enter the message into a Queue for forwarding to each of the multiple subscribed destinations. The Pub/Sub's may be set up in a manner such that the final destination nodes, e.g. 454, subscribe with the source node 450. Such requests may be sent multihop from the final destination node 454 to the source node 450. Alternatively, the subscription may be programmed directly at the source 450. Subscription may be done once for a long time period of a month for example. For setting up the pub/subs, one option is for the pub/sub's to be set up at each DTN node, as the request travels multihop fashion from the destination 454 to the source 450. Another option is for the source node (first DTN node) 450 to receive its requests or be programmed with information about the destinations nodes, in which case the source node may initiate pub/sub's at each hop as it seeks a path (or multiple paths if needed for reliability) to each of the destinations.

The DTN middleware may process the URI's, the HTTP request method, and the header field in Bundle Block at each hop, to determine when to store the message for future transmission. In some embodiments, a message may be deliberately delayed based on knowledge of the delay tolerance of the data, the network load, or link conditions, or with a goal to aggregate messages for a future transmission for reducing power utilization or improved network utilization. As the data is forwarded, handling instructions associated with the bundle blocks may be stored at the resource location indicated by the URI. While the data may be stored at intermediate nodes, it may be queried using web queries if needed for diagnostics.

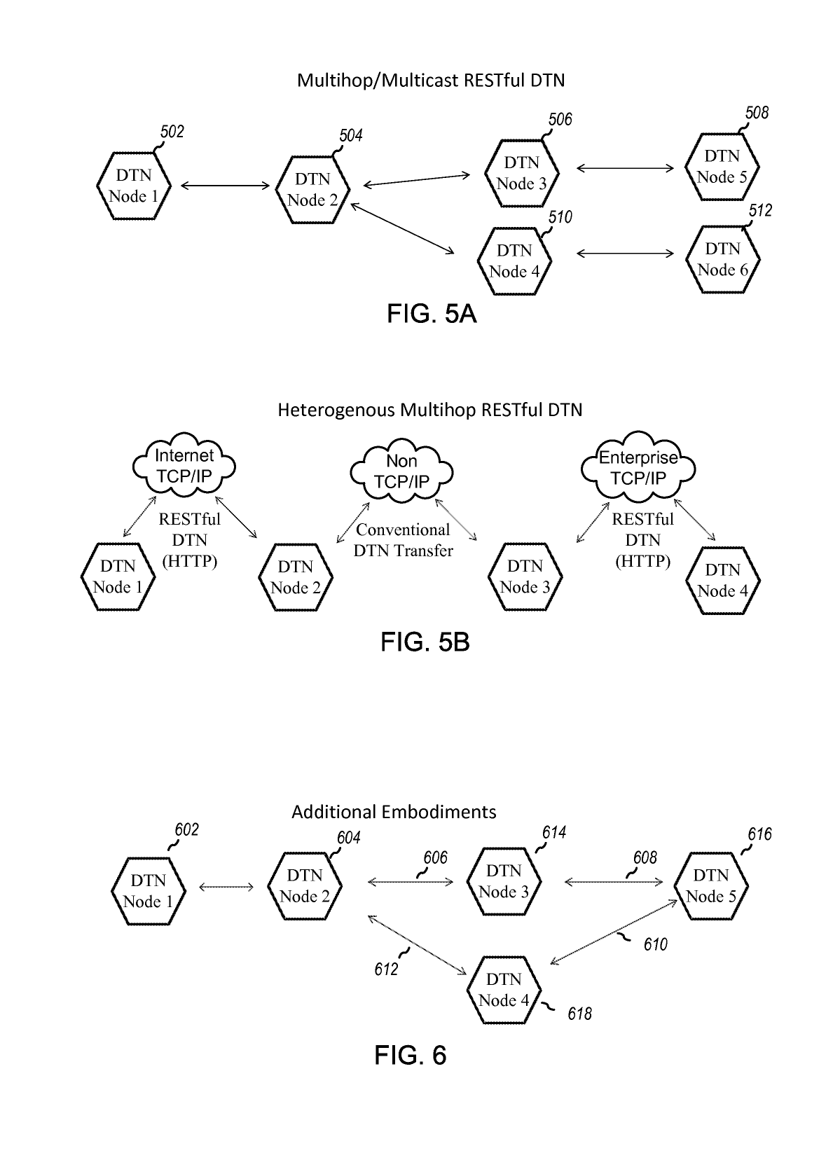

FIG. 5A is a block diagram of a RESTful DTN illustrating aspects that may be associated with multihop and multicast network configurations. Web-services-based DTN middleware may run on each DTN node, 502, 504, 506, 508, 510 and 512. RESTful DTN may be applied per hop, and may provide for ease of NAT/firewall traversal. Delay tolerance management may be performed with per-hop constraints. Different network policies may be managed for each hop. Security features may be applied per hop, including security per hop, for example, integrity checking, encryption, and/or authentication. Also, the status of messages may be queried per hop, and one-to-one, one-to-many, many-to-many and many-to-one mapping may be made per hop.

One-to-one, one-to-many, many-to-many, and many-to-one mapping are well known terms for communications addressing and delivery. In one-to-one mapping a message is passed directly between a first node and a second node only, i.e., from one device to an addressed other device. In one-to-many mapping, a message is sent by a single node to multiple receiving nodes. In many-to-many mapping, the same message originates from multiple source nodes, each of which sends the message to multiple receiving nodes. In many-to-one mapping, multiple source nodes send the same message to the same destination node. In all such configurations, the receiving node may disregard later received transactions that are identical to earlier received transactions. Sending the identical message across multiple nodes allows for fault tolerance because if the connection between the source node and one of the receiving nodes is lost, the message may still be sent to the second receiving node. Likewise, messages may be split and transmitted across different paths based on available bandwidth performance on each path.

The middleware at a node may proactively send test packets to multiple intermediate nodes to determine whether there is an available path to a destination node and wait for a response from middleware at each intermediate node. The availability of the various paths between nodes may be accumulated to enable more efficient routing of future messages.

Per hop confirmation may be achieved by each receiving node sending a confirmation message to the immediately preceding node upon receipt of the transaction by the receiving node. For example, upon receipt of a message, DTN Node 2 504 may send a confirmation message back to DTN Node 1 502, confirming receipt of the message. Alternatively, message forwarding confirmation may be achieved by the receiving node sending a confirmation message to the immediately preceding node after the receiving node has successfully forwarded the message to the next node or nodes in the sequence. For example, DTN Node 2 504 may send a message to DTN Node 1 502 only after DTN Node 2 504 has successfully forwarded the message to DTN Node 3 506 and DTN Node 4 510. The various confirmations may be used individually or in conjunction with each other.

FIG. 5B shows a block diagram of a RESTful DTN in a heterogeneous multihop configuration. When nodes are interconnected over an Internet TCP/IP network, such as the network connecting DTN Node 1 and DTN Node 2, RESTful DTN over HTTP may be used for inter-node messaging. When a node communicates over a non-TCP/IP network, such as transactions between DTN Node 2 and DTN Node 3, messaging may take place using conventional DTN transfer protocols. Further, communications over other types of TCP/IP networks, such as an Enterprise TCP/IP network, between DTN Node3 and TDN Node 4, may take place using RESTful DTN over TCP/IP. In an embodiment, heterogeneous networks may be traversed using a combination of RESTful DTN and conventional DTN, depending upon the lower layer protocols of the intervening networks between the DTN nodes. Thus, the DTN nodes may perform network-aware processing per coarse hop (i.e., between networks having different lower layer protocols).

In an embodiment, web-query-based diagnostic applications may be used to determine the status of the network. Such applications may be resident at one or more DTN Nodes, and may provide information regarding link quality and/or utilization, message queue sizes, bandwidth utilization, per hop time delays, and/or aggregate time delays over multiple hops.

In another embodiment, web transaction management applications may be employed at one or more DTN nodes to control traffic through the network. Such control may be based on the metrics collected from the web-based diagnostic applications described above.

In another aspect, web sockets may be employed to perform transactions instead of encapsulating the bundle protocol messages in HTTP payloads. The web sockets may feature notifications between DTN nodes regarding the status of their communications.

Other embodiments may leverage redundant hops in the network to improve the reliability of communications. In some instances, multipath may be exploited to this effect. For example, as shown in FIG. 6, messages exchanged between DTN Node 2 and DTN Node 5, block 616, may travel along hops 606 and 608 through DTN Node 3, block 614, as well as along hops 610 and 612 through DTN Node 4, block 618. Given that any of these links may be intermittent, increasing the number of parallel paths by exploiting multipath may improve the probabilities of successful transmission/reception of messages between nodes. One-to-one, one-to-many, many-to-many and many-to-one mapping may be made per hop. Security features may be applied per hop, including security per hop, for example, integrity checking, encryption, and/or authentication. In some embodiments, nodes may be configured to create additional parallel paths in regions where hops are known to be particularly unreliable in order to improve reliability of transaction communications. In all such configurations, the receiving host may disregard later received transactions that are identical to earlier received transactions.

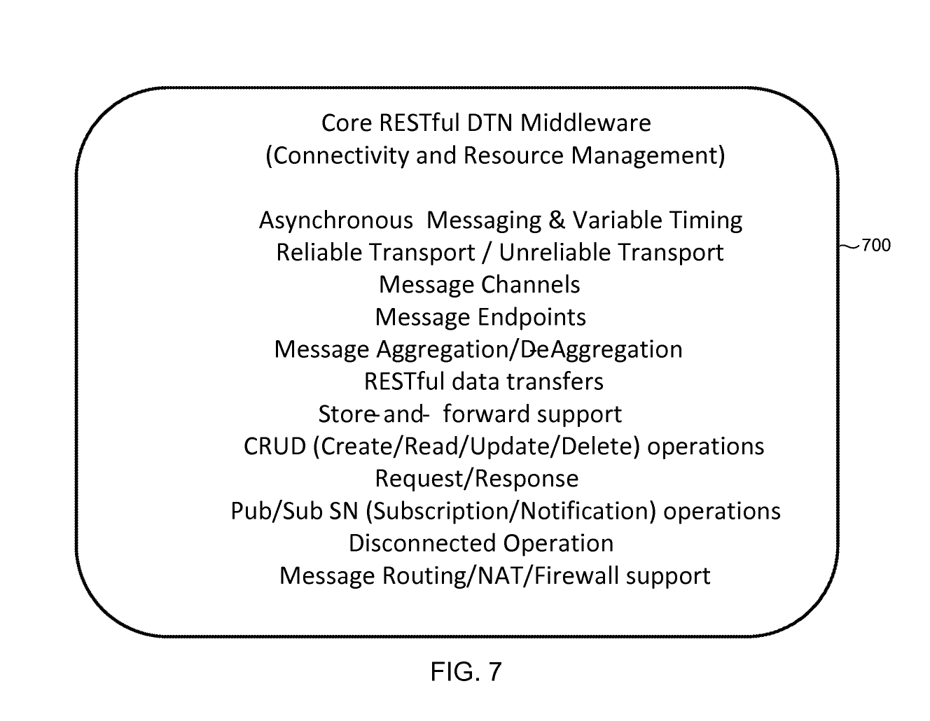

FIG. 7 is a block diagram illustrating an embodiment of the Core RESTful DTN Middleware 700. The RESTful DTN middleware may perform the functionality listed for providing messaging and connectivity support according to the various embodiments. Specifically, the Core RESTful DTN Middleware may be configured to support asynchronous messaging including messaging supporting variable timing, reliable as well as unreliable transport mechanisms, message channels, message endpoints, message aggregation and the aggregation, RESTful data transfers, store and forward messaging, Create/Read/Update/Delete operations, requests and responses, Pub/Sub SN (Subscription/Notification) operations, disconnected operations, and message routing/NAT/Firewall support.

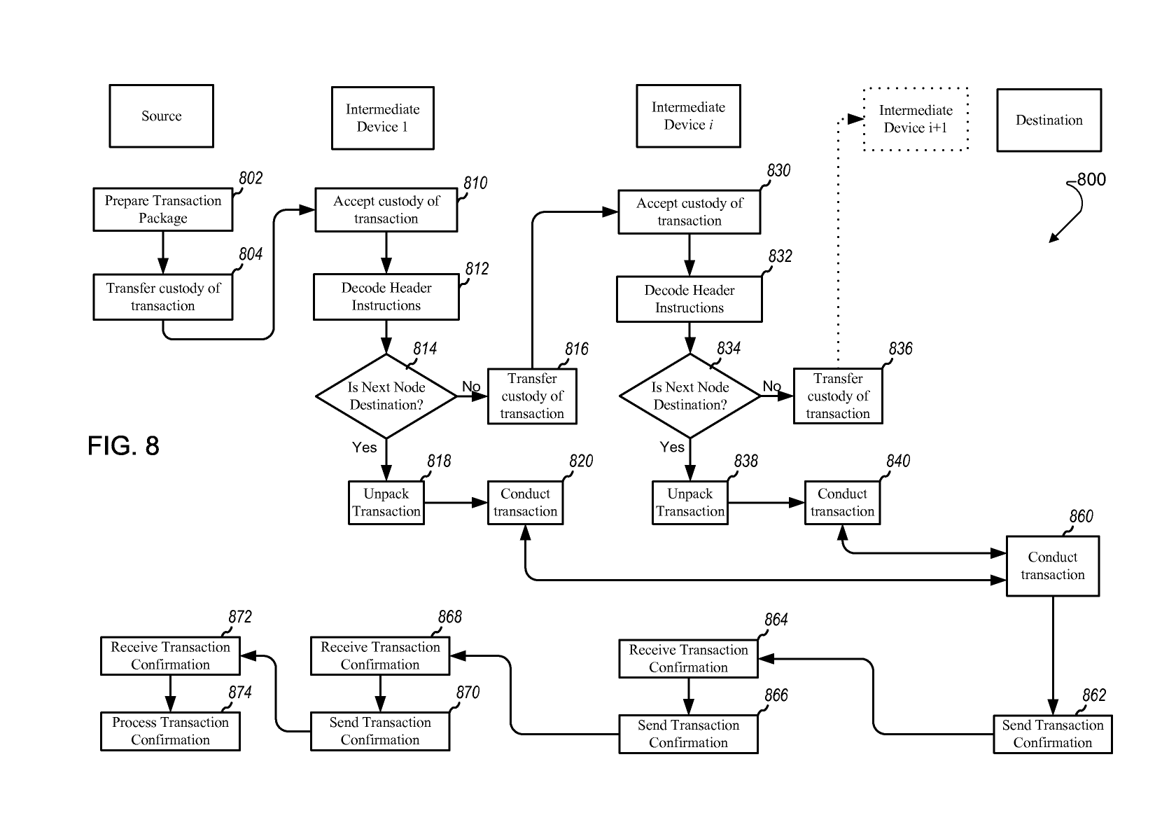

FIG. 8 is a process and signal flow diagram illustrating transactions between network devices, and the processes performed at the respective DTN devices. Methods may be performed at the Source, DTN Intermediate Devices 1 and 1, and the Destination as indicated. It should be understood that there may be many intermediate nodes beside the two illustrated in FIG. 8. The transfer of custody between one intermediate node and another intermediate node may be as illustrated and described herein for as many intermediate nodes as necessary.

In block 802, the processor in the Source may package an entire web transaction for transmission to the first intermediate device. The package may contain all data, handling instructions, priority values and other information necessary to conduct the transaction over a network. In block 804 the processor in the Source may transfer custody of the transaction package to the first intermediate device using standard HTTP transactions or by combining REST, SOAP or WSDL architectures with traditional delay tolerant networking techniques. The processor in the intermediate Device 1 may accept custody of the transaction in block 810. In an embodiment, as part of accepting custody of a transaction in block 810, the receiving Intermediate Device 1 may send an acknowledgment to the Source that custody of the transaction has been successfully transferred. In another embodiment, authentication of each node in the transfer may occur on each hop before custody is transferred.

Upon accepting custody in block 810, the processor in Intermediate Device 1 may decode the header instructions associated with the transaction in block 812 and may determine the next node to receive the transaction package. In determination block 814 the processor may determine whether the next node is the ultimate destination or another intermediate node. If the next node is another intermediate node (i.e., determination block 814=“no”), in block 816, the processor may transfer custody of the transaction to the next Intermediate Device I, which in turn may accept custody of the transaction in block 830. This process of delegating the transaction to the next intermediate node may be repeated in much the same manner for each Intermediate Device i until the intermediate device determines in determination block 834 that the next node is the ultimate destination.

When the Intermediate Device i processor determines that the next node is the ultimate destination (i.e., determination block 814 or determination block 834=“yes”), the processor may unpack the transaction in block 818, 838 and conduct the transaction in block 820, 840 with the ultimate Destination in block 860. The communications in blocks 820, 840 and 860 between the Intermediate Device i processor and the ultimate Destination may be handled in a manner similar to how the original Source would have handled the transaction with the Destination if those nodes had been in communication via a reliable (i.e., not intermittent) communication link (i.e., without the involvement of any intermediate nodes).

Upon completion of the transaction at block 860, the Destination may transmit a transaction confirmation signal back to the final Intermediate Device i as required by the transaction. Intermediate Device i may receive the transaction confirmation in block 864 and in turn send the transaction confirmation to the next earlier intermediate device in block 866. This receiving and sending of a transaction confirmation signal is recursive through all previous intermediate nodes, such as illustrated in blocks 868 and 870, until the first Intermediate Device 1 sends the transaction confirmation back to the Source in block 872. The processor in the Source may process the transaction confirmation in block 874 according to instructions associated with the original transaction.

In addition to confirmation of transaction completion, transaction progress confirmation may occur at multiple points throughout the transaction process. For example, per hop confirmation may be achieved by each receiving node sending a confirmation message to the immediately preceding node upon receipt of the transaction by the receiving node. Alternatively, message forwarding confirmation may be achieved by the receiving node sending a confirmation message to the immediately preceding node after the receiving node has successfully forwarded the message to the next node in the sequence.

Each of the various confirmations may be accomplished together or separately, and may be accomplished using the same multi-hop delay tolerant techniques employed for the original transaction wherein multiple intermediate devices accept custody of the transaction confirmation and transfer the transaction confirmation to subsequent intermediate nodes until the original source receives the transaction confirmation. The return confirmation signal may travel in one-to-one, one-to-many, many-to-one, or many-to-many relationships between nodes, however, the return path of the confirmation signals need not be through the same intermediate devices as the original transaction, and normal routing via HTTP, TCP/IP, email and other communication protocols may be used.

In an alternative configuration, each node may send appropriate confirmation messages to a transaction manager node. The source node, and all other sending nodes to which a confirmation message would normally be sent, may query the transaction manager node for their respective confirmations. Alternatively, the transaction manager node may push confirmation messages received from receiving nodes to the respective sending nodes.

By way of illustration, consider a case in which a source node sends an initial message to a destination node by first sending it an intermediary node with instructions for the intermediary node to forward it to the source node within some delay tolerance bounds. In this situation there are three messages that the intermediary node may send to the source node. First, the intermediary node may reply to the source node with a receipt confirmation message (i.e., confirming receipt of the initial message). Second, the intermediary node may send to the source node a forwarding confirmation message after the intermediary node has forwarded the initial message along a path to the destination node (such as via a fourth node) after some delay. Finally, the intermediary node may send a transaction completion message to the source node, which may be a transaction completion message that the intermediary node receives from the destination node on a return path. Such a transaction completion message may not be sent by the intermediary node because it could be sent to the source node by the destination node (i.e., via a return path that is different from the outgoing path). Also, a transaction completion message could be sent to the source node by a transaction manager node as mentioned above. It should be noted that each intermediary node in a delivery path may return the three messages described above to the preceding intermediary node. Thus, there may be per-hop confirmations on message reception confirmation, message forwarding confirmation, and end-to-end confirmation messages upon transaction completion that may all flow back from the destination node.

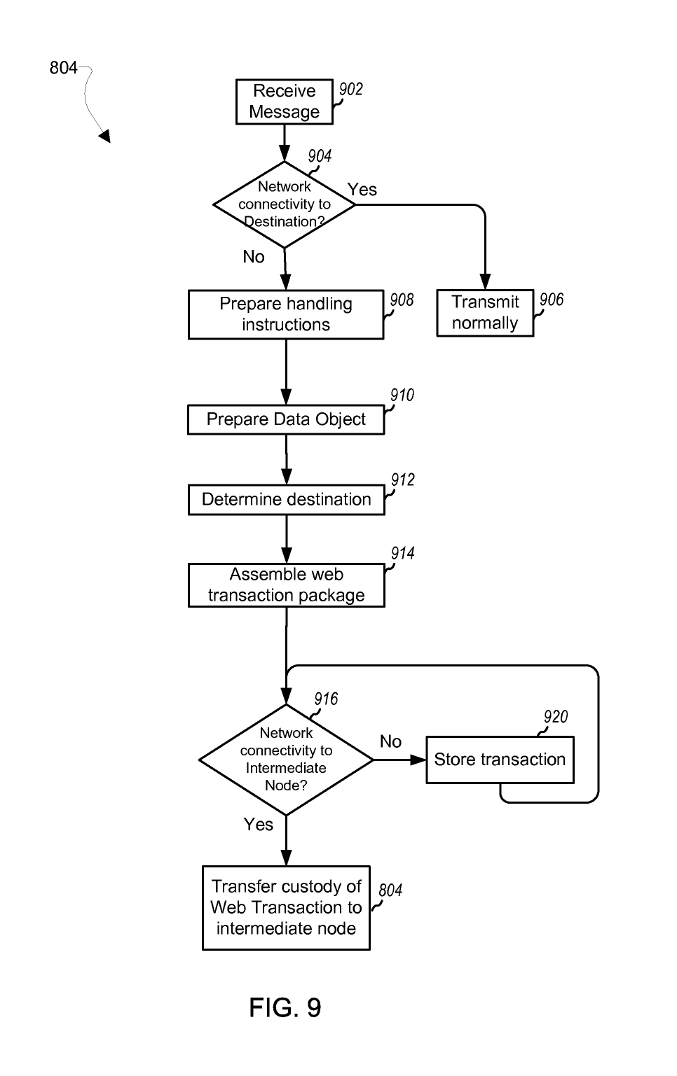

FIG. 9 illustrates an embodiment method 804 for preparing transaction packages in the source node as mentioned above with respect to block 804 in FIG. 8. In block 902 the processor in the Source node may receive a series of messages which comprise a robust web transaction. The Source Node processor may determine in determination block 904 whether a stable continuous network connection can be made and maintained between the Source and the Destination sufficient to enable an ordinary online transaction. If a continuous network connection is possible to the Destination (i.e., determination block 904=“Yes”), the Source processor may conduct the transaction with the Destination using traditional online transaction techniques in block 906, such as using HTTP, TCP/IP or other common transfer protocols.

If in determination block 904 the processor determines that a stable continuous network connection from the Source to the Host is not available (i.e., determination block 904=“No”), the processor may prepare handling instructions for the transaction in block 908 that enable delegating completion of the transaction to an intermediate node. The handling instructions may include variable delay tolerances, such as emergency (e.g., urgent, medium or low) that intermediate nodes may use to determine the urgency of the transaction, and thus how quickly a transaction must pass through the various nodes to reach the Destination. Less urgent transactions may be delayed in favor of more urgent transactions. Handling instructions may also include instructions to be executed by one or more intermediate nodes as the transaction is delegated from node to node before reaching the Destination server.

In block 910 the source processor may prepare the data object which comprises all the data necessary to conduct the transaction. In block 912 the source processor may determine the ultimate destination for the transaction and the optimal transmission path. This operation may involve well-known TCP/IP protocol techniques commonly implemented in the Internet. In an embodiment, the source processor may estimate delay across the transmission path based on past connectivity data or network information available from Internet routing information sources. In block 914 the source processor may combine the handling instructions and data object into a transaction package. The transaction package may be in the form of encapsulated HTTP payloads or other suitable data packages. In determination block 916 the source processor may determine whether there is continuous network connectivity to the first intermediate node. If so (i.e., determination block 916=“yes”), the source processor may transmit the transaction package to the first intermediate node in block 804, thereby delegating completion of the entire transaction to the first intermediate node. If the source processor determines that there is not continuous network connectivity to the first intermediate node (i.e., determination block 916=“no”), in block 920 the source processor may store the transaction package in memory and periodically check for continuous network connectivity in determination block 916 until either the transaction is successfully transmitted or the lifespan for the transaction is exceeded (i.e., the transaction expires).

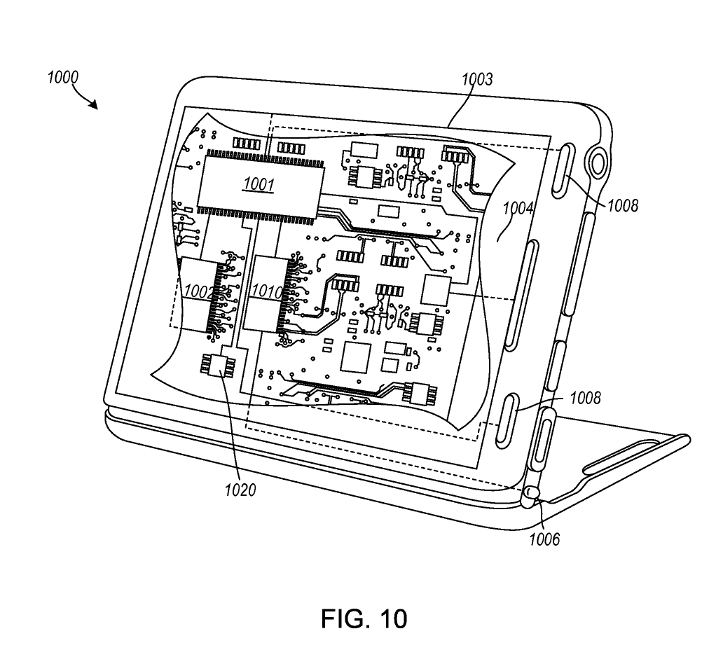

The various embodiments may be implemented in and/or with any of a variety of Source node computing devices, such as a mobile telephone, a further example of which is illustrated in FIG. 10 in the form of a partial section view of a cellular telephone. Typical mobile computing devices 1000 will have in common the components illustrated in FIG. 10. For example, mobile computing devices 1000 may include a processor 1001 coupled to an internal memory 1002 and a touch surface input device/display 1003, such as a resistive sensing touch-screen 1004, capacitive sensing touch-screen, infrared sensing touch-screen, acoustic/piezoelectric sensing touch-screen, or the like. The mobile computing device 1000 may have a radio/antenna 1006 for sending and receiving electromagnetic radiation that is connected to a wireless data link and/or cellular telephone transceiver 1020 coupled to the processor 1001. Mobile computing devices 1000 may also include a GPS receiver coupled to the processor 1001 for determining locations of the device. Mobile computing devices 1000 may also include physical buttons 1008 for receiving user inputs.

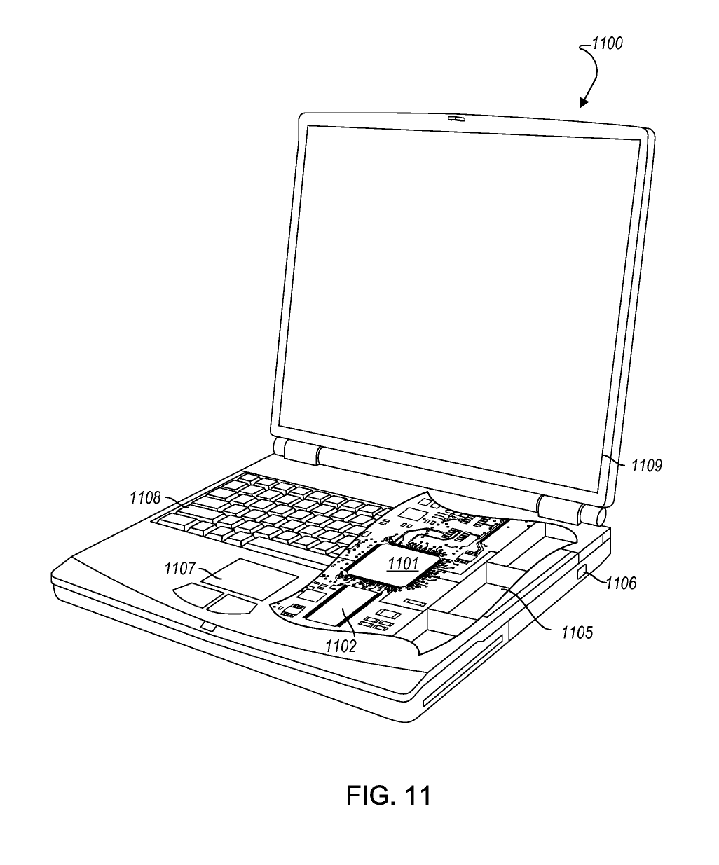

The various embodiments described above may also be implemented within and/or with a variety of personal computing devices functioning as the Source node, such as a laptop computer 1100 as illustrated in FIG. 11. Many laptop computers include a touch pad touch surface 1107 that serves as the computer's pointing device, and thus may receive drag, scroll, and flick gestures similar to those implemented on mobile computing devices equipped with a touch screen display and described above. A laptop computer 1100 will typically include a processor 1101 coupled to volatile memory and a large capacity nonvolatile memory, such as a flash memory device 1102. The laptop computer 1100 may also include a floppy disc drive and a compact disc (CD) drive coupled to the processor 1101. The laptop computer 1100 may also include a number of network transceivers or network connector ports 1106 coupled to the processor 1101 configured to enable the processor 1102 to communicate with other computing devices one or more wired or wireless networks. As a particular example, the network transceivers of a laptop computer 1100 may include Ethernet, USB or FireWire® connector sockets/transceivers, one or more wireless modem transceivers, such as Wi-Fi and/or cellular data network transceivers, coupled to one or more antenna for sending and receiving electromagnetic radiation. The laptop computer 1100 may also include other types of network connection circuits for coupling the processor 1101 to a network that may be developed in the future. In a notebook configuration, the computer housing 1105 includes the touchpad 1107, the keyboard 1108, and the display 1109 all coupled to the processor 1101. Other configurations of the computing device may include a computer mouse or trackball coupled to the processor (e.g., via a USB input) as are well known, which may also be used in conjunction with the various embodiments.

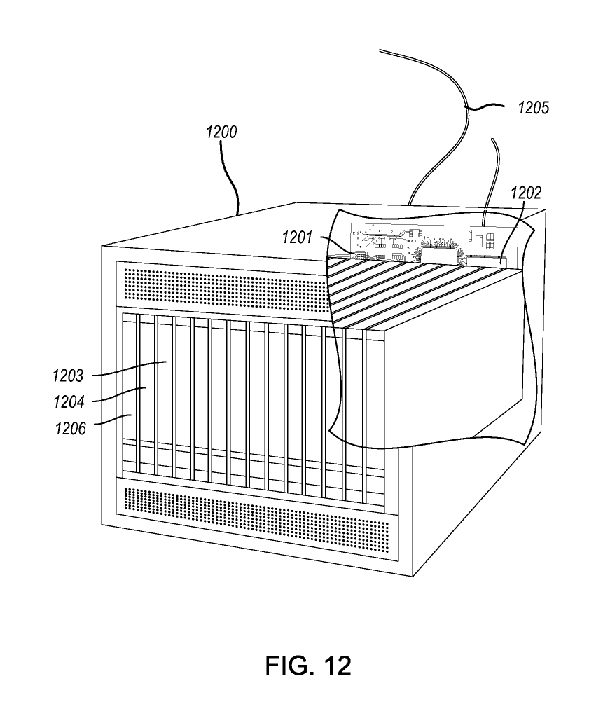

Various embodiments may be implemented on any of a variety of commercially available server devices, such as the server 1200 illustrated in FIG. 12. Such a server 1200 typically includes a processor 1201 coupled to volatile memory 1202 and a large capacity nonvolatile memory, such as a disk drive 1203. The server 1200 may also include a floppy disc drive, compact disc (CD) or DVD disc drive 1206 coupled to the processor 1201. The server 1200 may also include network access ports 1204 coupled to the processor 1201 for establishing data connections with a network 1205, such as a local area network coupled to other communication system computers and servers.

The processors 1101, 1101, 1201 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor dedicated to wireless communication functions and one processor dedicated to running other applications. Typically, software applications may be stored in the internal memory 1002, 1102, 1202 and 1203 before they are accessed and loaded into the processor 1101, 1101 and 1201. The processor 1101, 1101 and 1201 may include internal memory sufficient to store the application software instructions.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The functions in the various embodiments may be implemented in hardware, software, firmware, or any combination thereof. If implemented in software, the functions may be stored as one or more processor-executable instructions or code on a non-transitory computer-readable medium or non-transitory processor-readable medium. The steps of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A method for providing robust web transactions over a network exhibiting intermittent conductivity between a source computing device and a destination device, comprising:
combining Delay Tolerant Networking (DTN) techniques with a Representational State Transfer (REST) architecture to enable transmission of web transactions over networks with intermittent connectivity by delegating an entire transaction to intermediate network nodes.

2. The method of claim 1, wherein delegating the entire transaction to intermediate nodes comprises:
aggregating, in the source computing device, a sequence of operations constituting the web transaction between the source computing device and the destination device;
combining, in the source computing device, data objects and handling instructions, including delay tolerance information for the web transaction, into a set of messages constituting the web transaction;
encapsulating data of the set of messages in bundles using HTTP payloads; and
delegating the set of messages from the source computing device to an intermediate device in a manner that enables the intermediate device to complete the web transaction with the destination device on behalf of the source computing device.

3. The method of claim 2, further comprising:
combining, in the destination device, a confirmation message, handling instructions, including delay tolerance information for the confirmation message into a confirmation package;
encapsulating data of the confirmation package in bundles using HTTP payloads; and
delegating the confirmation package from the destination device to an intermediate device.

4. A method for providing robust web transactions over a network, comprising:
receiving at a first network node a set of messages constituting a web transaction, a data object, handling instructions and delay tolerance parameters from one of a source computing device and another network node;
determining whether sufficient network connectivity exists between the first network node and a destination of the web transaction to enable completion of the web transaction;
completing, by the first network node, the web transaction on behalf of the source computing device by transmitting the set of messages to the destination according to the handling instructions in response to determining that there is sufficient network connectivity between the first network node and the destination to complete the web transaction; and
forwarding to a second network node the set of messages constituting a web transaction, a data object, handling instructions and delay tolerance parameters in response to determining that there is insufficient network connectivity between the first network node and the destination to complete the web transaction.

5. The method of claim 4, further comprising:
combining, in the destination device, a confirmation message, handling instructions, including delay tolerance information for the confirmation message into a confirmation package;
encapsulating data of the confirmation package in bundles using HTTP payloads; and
delegating the confirmation package from the destination device to an intermediate device.

6. The method of claim 4, wherein communications of and with the network node are accomplished according to a Representational State Transfer (REST) architecture.

7. The method of claim 4, wherein communications of and with the network node are accomplished according to a Simple Object Access Protocol (SOAP) architecture.

8. The method of claim 4, wherein forwarding to a second network node the set of messages constituting a web transaction, a data object, handling instructions and delay tolerance parameters comprises:
determining the second network node to which the web transaction should be relayed; and
delegating the web transaction to the second network node.

9. The method of claim 4, further comprising:
determining whether there is network connectivity to the second network node sufficient to transmit the set of messages constituting a web transaction, a data object, handling instructions and delay tolerance parameters;
transmitting the set of messages constituting a web transaction, a data object, handling instructions and delay tolerance parameters in response to determining that there is sufficient network connectivity to complete the transmission; and
storing the web transaction, a data object, handling instructions and delay tolerance parameters for later transmission in response to determining that there is insufficient network connectivity to complete the transmission.

10. The method of claim 4, further comprising:
determining from the delay tolerance parameters whether the web transaction has expired;
transmitting the set of messages constituting a web transaction, a data object, handling instructions and delay tolerance parameters in response to determining that the web transaction has not expired; and
deleting the set of messages constituting a web transaction, a data object, handling instructions and delay tolerance parameters in response to determining that the web transaction has expired.

11. The method of claim 4, further comprising:
scheduling transmission of the web transaction, a data object, handling instructions and delay tolerance parameters to the second network node based on the delay tolerance parameters.

12. The method of claim 11, wherein scheduling transmission of the web transaction, a data object, handling instructions and delay tolerance parameters to the second network node based on the delay tolerance parameters comprises expediting transmission of the web transaction to the second network node in response to determining that the web transaction will soon expire.

13. A source computing device, comprising:
a network interface; and
a processor coupled to the network interface, wherein the processor is configured with processor-executable instructions to perform operations comprising:
aggregating a sequence of operations constituting the web transaction between the source computing device and the destination device;
combining data objects and handling instructions, including delay tolerance information for the web transaction, into a set of messages constituting the web transaction;
encapsulating data of the set of messages in bundles using HTTP payloads; and
delegating the set of messages to an intermediate device in a manner that enables the intermediate device to complete the web transaction with the destination device on behalf of the source computing device.

14. A source computing device, comprising:
means for aggregating, in the source computing device, a sequence of operations constituting the web transaction between the source computing device and the destination device;
means for combining, in the source computing device, data objects and handling instructions, including delay tolerance information for the web transaction, into a set of messages constituting the web transaction;
means for encapsulating data of the set of messages in bundles using HTTP payloads; and
means for delegating the set of messages from the source computing device to an intermediate device in a manner that enables the intermediate device to complete the web transaction with the destination device on behalf of the source computing device.

15. A non-transitory computer-readable storage medium having stored thereon processor executable instructions configured to cause a computing device processor to perform operations comprising:
aggregating, in the source computing device, a sequence of operations constituting the web transaction between the source computing device and the destination device;
combining, in the source computing device, data objects and handling instructions, including delay tolerance information for the web transaction, into a set of messages constituting the web transaction;
encapsulating data of the set of messages in bundles using HTTP payloads; and
delegating the set of messages from the source computing device to an intermediate device in a manner that enables the intermediate device to complete the web transaction with the destination device on behalf of the source computing device.

16. A server configured to function as a first network node in a communication network, comprising:
a network interface; and
a processor coupled to the network interface, wherein the processor is configured with processor-executable instructions to perform operations comprising:
receiving a set of messages constituting a web transaction, a data object, handling instructions and delay tolerance parameters from one of a source computing device and another network node;
determining whether sufficient network connectivity exists between the server and a destination of the web transaction to enable completion of the web transaction;
completing the web transaction on behalf of the source computing device by transmitting the set of messages to the destination according to the handling instructions in response to determining that there is sufficient network connectivity between the server and the destination to complete the web transaction; and
forwarding to a second network node the set of messages constituting a web transaction, a data object, handling instructions and delay tolerance parameters in response to determining that there is insufficient network connectivity between the server and the destination to complete the web transaction.

17. The server of claim 16, wherein the processor is configured with processor-executable instructions to perform operations such that communications of and with the server are accomplished according to a Representational State Transfer (REST) architecture.

18. The server of claim 16, wherein the processor is configured with processor-executable instructions to perform operations such that communications of and with the server are accomplished according to a Simple Object Access Protocol (SOAP) architecture.

19. The server of claim 16, wherein the processor is configured with processor-executable instructions to perform operations such that forwarding to a second network node the set of messages constituting a web transaction, a data object, handling instructions and delay tolerance parameters comprises:
determining the second network node to which the web transaction should be relayed; and
delegating the web transaction to the second network node.

20. The server of claim 16, wherein the processor is configured with processor-executable instructions to perform operations further comprising:
determining whether there is network connectivity to the second network node sufficient to transmit the set of messages constituting a web transaction, a data object, handling instructions and delay tolerance parameters;
transmitting the set of messages constituting a web transaction, a data object, handling instructions and delay tolerance parameters in response to determining that there is sufficient network connectivity to complete the transmission; and
storing the web transaction, a data object, handling instructions and delay tolerance parameters for later transmission in response to determining that there is insufficient network connectivity to complete the transmission.

21. The server of claim 16, wherein the processor is configured with processor-executable instructions to perform operations further comprising:
determining from the delay tolerance parameters whether the web transaction has expired;
transmitting the set of messages constituting a web transaction, a data object, handling instructions and delay tolerance parameters in response to determining that the web transaction has not expired; and
deleting the set of messages constituting a web transaction, a data object, handling instructions and delay tolerance parameters in response to determining that the web transaction has expired.

22. The server of claim 16, wherein the processor is configured with processor-executable instructions to perform operations further comprising:
scheduling transmission of the web transaction, a data object, handling instructions and delay tolerance parameters to the second network node based on the delay tolerance parameters.

23. The server of claim 22, wherein the processor is configured with processor-executable instructions to perform operations such that scheduling transmission of the web transaction, a data object, handling instructions and delay tolerance parameters to the second network node based on the delay tolerance parameters comprises expediting transmission of the web transaction to the second network node in response to determining that the web transaction will soon expire.

24. A server configured to function as a first network node in a communication network, comprising:
means for receiving at a first network node a set of messages constituting a web transaction, a data object, handling instructions and delay tolerance parameters from one of a source computing device and another network node;
means for determining whether sufficient network connectivity exists between the first network node and a destination of the web transaction to enable completion of the web transaction;
means for completing, by the first network node, the web transaction on behalf of the source computing device by transmitting the set of messages to the destination according to the handling instructions in response to determining that there is sufficient network connectivity between the first network node and the destination to complete the web transaction; and
means for forwarding to a second network node the set of messages constituting a web transaction, a data object, handling instructions and delay tolerance parameters in response to determining that there is insufficient network connectivity between the first network node and the destination to complete the web transaction.

25. The server of claim 24, wherein communications of and with the network node are accomplished according to a Representational State Transfer (REST) architecture.

26. The server of claim 24, wherein communications of and with the network node are accomplished according to a Simple Object Access Protocol (SOAP) architecture.

27. The server of claim 24, wherein means for forwarding to a second network node the set of messages constituting a web transaction, a data object, handling instructions and delay tolerance parameters comprises:
means for determining the second network node to which the web transaction should be relayed; and
means for delegating the web transaction to the second network node.

28. The server of claim 24, further comprising:
means for determining whether there is network connectivity to the second network node sufficient to transmit the set of messages constituting a web transaction, a data object, handling instructions and delay tolerance parameters;
means for transmitting the set of messages constituting a web transaction, a data object, handling instructions and delay tolerance parameters in response to determining that there is sufficient network connectivity to complete the transmission; and
means for storing the web transaction, a data object, handling instructions and delay tolerance parameters for later transmission in response to determining that there is insufficient network connectivity to complete the transmission.

29. The server of claim 24, further comprising:
means for determining from the delay tolerance parameters whether the web transaction has expired;
means for transmitting the set of messages constituting a web transaction, a data object, handling instructions and delay tolerance parameters in response to determining that the web transaction has not expired; and
means for deleting the set of messages constituting a web transaction, a data object, handling instructions and delay tolerance parameters in response to determining that the web transaction has expired.

30. The server of claim 24, further comprising:
means for scheduling transmission of the web transaction, a data object, handling instructions and delay tolerance parameters to the second network node based on the delay tolerance parameters.

31. The server of claim 24, wherein means for scheduling transmission of the web transaction, a data object, handling instructions and delay tolerance parameters to the second network node based on the delay tolerance parameters further comprises means for expediting transmission of the web transaction to the second network node in response to determining that the web transaction will soon expire.

32. A non-transitory computer-readable storage medium having stored thereon processor-executable instructions configured to cause a server processor to perform operations comprising:
receiving at a first network node a set of messages constituting a web transaction, a data object, handling instructions and delay tolerance parameters from one of a source computing device and another network node;
determining whether sufficient network connectivity exists between the first network node and a destination of the web transaction to enable completion of the web transaction;
completing, by the first network node, the web transaction on behalf of the source computing device by transmitting the set of messages to the destination according to the handling instructions in response to determining that there is sufficient network connectivity between the first network node and the destination to complete the web transaction; and
forwarding to a second network node the set of messages constituting a web transaction, a data object, handling instructions and delay tolerance parameters in response to determining that there is insufficient network connectivity between the first network node and the destination to complete the web transaction.

33. The non-transitory computer-readable storage medium of claim 32, wherein the stored processor-executable instructions are configured to cause a server processor to perform operations such that communications of and with the network node are accomplished according to a Representational State Transfer (REST) architecture.

34. The non-transitory computer-readable storage medium of claim 32, wherein the stored processor-executable instructions are configured to cause a server processor to perform operations such that communications of and with the network node are accomplished according to a Simple Object Access Protocol (SOAP) architecture.

35. The non-transitory computer-readable storage medium of claim 32, wherein the stored processor-executable instructions are configured to cause a server processor to perform operations such that forwarding to a second network node the set of messages constituting a web transaction, a data object, handling instructions and delay tolerance parameters comprises:
determining the second network node to which the web transaction should be relayed; and
delegating the web transaction to the second network node.

36. The non-transitory computer-readable storage medium of claim 32, wherein the stored processor executable instructions are configured to cause the computing device processor to perform operations further comprising:
determining whether there is network connectivity to the second network node sufficient to transmit the set of messages constituting a web transaction, a data object, handling instructions and delay tolerance parameters;
transmitting the set of messages constituting a web transaction, a data object, handling instructions and delay tolerance parameters in response to determining that there is sufficient network connectivity to complete the transmission; and
storing the web transaction, a data object, handling instructions and delay tolerance parameters for later transmission in response to determining that there is insufficient network connectivity to complete the transmission.

37. The non-transitory computer-readable storage medium of claim 32, wherein the stored processor executable instructions are configured to cause the computing device processor to perform operations further comprising:
determining from the delay tolerance parameters whether the web transaction has expired;
transmitting the set of messages constituting a web transaction, a data object, handling instructions and delay tolerance parameters in response to determining that the web transaction has not expired; and
deleting the set of messages constituting a web transaction, a data object, handling instructions and delay tolerance parameters in response to determining that the web transaction has expired.

38. The non-transitory computer-readable storage medium of claim 32, wherein the stored processor executable instructions are configured to cause the computing device processor to perform operations further comprising:
scheduling transmission of the web transaction, a data object, handling instructions and delay tolerance parameters to the second network node based on the delay tolerance parameters.

39. The non-transitory computer-readable storage medium of claim 38, wherein scheduling transmission of the web transaction, a data object, handling instructions and delay tolerance parameters to the second network node based on the delay tolerance parameters comprises expediting transmission of the web transaction to the second network node in response to determining that the web transaction will soon expire.

40. A computing device configured to function as a transaction destination computer, comprising:
a network interface; and
a processor coupled to the network interface, wherein the processor is configured with processor-executable instructions to perform operations comprising:
combining into a confirmation package a confirmation message confirming completion of a transaction initiated by a source computing device that was delegated for completion by an intermediary computing device, handling instructions, including delay tolerance information for the confirmation message;
encapsulating data of the confirmation package in bundles using HTTP payloads; and
delegating the confirmation package from the destination device to an intermediate device.

41. A computing device configured to function as a transaction destination computer, comprising:
means for combining into a confirmation package a confirmation message confirming completion of a transaction initiated by a source computing device that was delegated for completion by an intermediary computing device, handling instructions, including delay tolerance information for the confirmation message;
means for encapsulating data of the confirmation package in bundles using HTTP payloads; and
means for delegating the confirmation package to an intermediate computing device for delivery to a source computing device.

42. A non-transitory computer-readable storage medium having stored thereon processor executable instructions configured to cause a computing device processor to perform operations to function as a transaction destination computer comprising:
combining into a confirmation package a confirmation message confirming completion of a transaction initiated by a source computing device that was delegated for completion by an intermediary computing device, handling instructions, including delay tolerance information for the confirmation message;
encapsulating data of the confirmation package in bundles using HTTP payloads; and
delegating the confirmation package from the destination device to an intermediate device.

43. A system for providing robust web transactions over a network exhibiting intermittent conductivity, comprising:
a source computing device;
a server functioning as an intermediate network node; and
a destination computing device,
wherein the source computing device, the server functioning as an intermediate network node and the destination computing device are configured to combine Delay Tolerant Networking (DTN) techniques with a Representational State Transfer (REST) architecture to enable transmission of web transactions over networks with intermittent connectivity by delegating the entire transaction to the server functioning as an intermediate network node.

44. The system of claim 43, further comprising:
a source computing device coupled to a communications network;
a first network node server coupled to the communication network; and
a destination computing device coupled to the communication network,
wherein the source computing device comprises a network interface and a processor coupled to the network interface, wherein the processor is configured with processor-executable instructions to perform operations comprising:
aggregating a sequence of operations constituting the web transaction with the destination device;
combining data objects and handling instructions, including delay tolerance information for the web transaction, into a set of messages constituting the web transaction;
encapsulating data of the set of messages in bundles using HTTP payloads; and
delegating the set of messages to the first network node server in a manner that enables the first network node server to complete the web transaction with the destination computing device on behalf of the source computing device.

45. The system of claim 43, wherein the first network node server comprises:
a memory;
a network interface; and
a server processor coupled to the memory and network interface, wherein the server processor is configured with processor-executable instructions to perform operations comprising:
receiving the set of messages from source computing device;
determining whether sufficient network connectivity exists with the destination computing device to enable completion of the web transaction;
completing the web transaction on behalf of the source computing device by transmitting the set of messages to the destination computing device according to the handling instructions in response to determining that there is sufficient network connectivity with the destination computing device to complete the web transaction; and
forwarding to a second network node the set of messages constituting the web transaction, a data object, handling instructions and delay tolerance parameters in response to determining that there is insufficient network connectivity with the destination computing device to complete the web transaction.

46. The system of claim 43, wherein communications between the source computing device and the first network node server are accomplished according to a Representational State Transfer (REST) architecture.

47. The system of claim 43, wherein communications between the source computing device and the first network node server are accomplished according to a Simple Object Access Protocol (SOAP) architecture.

48. The system of claim 43, wherein the server processor is configured with processor-executable instructions to perform operations such that forwarding to a second network node the set of messages constituting a web transaction, a data object, handling instructions and delay tolerance parameters comprises:
determining the second network node to which the web transaction should be relayed; and
delegating the web transaction to the second network node.

49. The system of claim 43, wherein the server processor is configured with processor-executable instructions to perform operations further comprising:
determining whether there is network connectivity to the second network node sufficient to transmit the set of messages constituting a web transaction, a data object, handling instructions and delay tolerance parameters;
transmitting the set of messages constituting a web transaction, a data object, handling instructions and delay tolerance parameters in response to determining that there is sufficient network connectivity to complete the transmission; and
storing the web transaction, a data object, handling instructions and delay tolerance parameters for later transmission in response to determining that there is insufficient network connectivity to complete the transmission.

50. The system of claim 43, wherein the server processor is configured with processor-executable instructions to perform operations further comprising:
determining from the delay tolerance parameters whether the web transaction has expired;
transmitting the set of messages constituting a web transaction, a data object, handling instructions and delay tolerance parameters in response to determining that the web transaction has not expired; and
deleting the set of messages constituting a web transaction, a data object, handling instructions and delay tolerance parameters in response to determining that the web transaction has expired.

51. The system of claim 43, wherein the server processor is configured with processor-executable instructions to perform operations further comprising:
scheduling transmission of the web transaction, a data object, handling instructions and delay tolerance parameters to the second network node based on the delay tolerance parameters.

52. The system of claim 43, wherein the server processor is configured with processor-executable instructions to perform operations such that scheduling transmission of the web transaction, a data object, handling instructions and delay tolerance parameters to the second network node based on the delay tolerance parameters comprises expediting transmission of the web transaction to the second network node in response to determining that the web transaction will soon expire.

53. The system of claim 43, further comprising:
a destination computing device coupled to a communications network and comprising:
a destination computer processor configured with processor-executable instructions to perform operations comprising:
combining a confirmation message, handling instructions, including delay tolerance information for the confirmation message into a confirmation package;
encapsulating data of the confirmation package in bundles using HTTP payloads; and
delegating delivery of the confirmation package to the first network node server.
